(19) United States
(12) Patent Application Publication
(10) Pub. No.: US 2012/0265542 A1
(43) Pub. Date: Oct. 18, 2012

(54) OPTIMIZED PARAMETRIC STEREO DECODING

(75) Inventors: Balazs Kovesi, Lannion (FR); Stephane Ragot, Lannion (FR); Thi Minh Nguyet Hoang, Sundbyberg (SE)

(73) Assignee: FRANCE TELECOM, Paris (FR)

(21) Appl. No.: 13/502,319

(22) PCT Filed: Oct. 15, 2010
(86) PCT No.: PCT/FR2010/052193

§ 371 Date: Jul. 2, 2012

(30) Foreign Application Priority Data
Oct. 16, 2009 (FR) 09 57297

(51) Int. Cl. G10L 19/00

(52) U.S. Cl. 704/500; 704/E19.001

(57) ABSTRACT

A method and decoder are provided for parametrically decoding a stereo digital audio signal. The method includes synthesizing the stereo signal, per frequency sub-band, on the basis of a decoded mono signal (\hat{M}[j]), arising from a downmix of the stereo signal and from spatial information parameters of the stereo signal, in such a way that the signals obtained have the following form:

$$\hat{L} [ j ] = {c}_{1} [ j ] \cdot {\hat{M}}_{1} [ j ]$$

$$\hat{R} [ j ] = {c}_{2} [ j ] \cdot {\hat{M}}_{2} [ j ] ,$$

with \hat{L}[j] and \hat{R}[j] being channels of the synthesized signal, \hat{M}₁[j] and \hat{M}₂[j] being signals that are a function of the decoded mono signal and c₁[j], c₂[j] being gains, wherein the gains are calculated as follows:

$${c}_{1} [ j ] = \frac{2 \hat{I} [ j ]}{\hat{I} [ j ] + 1}$$

$${c}_{2} [ j ] = \frac{2}{\hat{I} [ j ] + 1}$$

with Î[j] being an amplitude ratio between the two channels of the stereo signal, obtained from the decoded parameters.

### CROSS-REFERENCE TO RELATED APPLICATIONS

This application is a Section 371 National Stage Application of International Application No. PCT/FR2010/052193, filed Oct. 15, 2010, which is incorporated by reference in its entirety and published as WO 2011/045549 on Apr. 21, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The present disclosure relates to the field of digital signal coding/decoding.

The coding and decoding according to the disclosure is suited in particular to the transmission and/or storage of digital signals such as audiofrequency signals (speech, music or similar).

More particularly, the present disclosure relates to the parametric coding/decoding of multichannel audio signals.

### BACKGROUND OF THE DISCLOSURE

This type of coding/decoding is based on the extraction of spatial information parameters so that, on decoding, these spatial characteristics can be restored for the listener.

This type of parametric coding is applied in particular for a stereo signal. Such a coding/decoding technique is, for example, described in the document by Breebaart, J. and van de Par, S and Kohlrausch, A. and Schuijers, entitled “Parametric Coding of Stereo Audio” in EURASIP Journal on Applied Signal Processing 2005:9, 1305-1322. This example is reprised with reference to FIGS. 1 and 2 respectively describing a parametric stereo coder and decoder.

Thus, FIG. 1 describes a coder receiving two audio channels, a left channel (denoted L) and a right channel (denoted R).

The channels L(n) and R(n) are processed by the blocks 101, 102 and 103, 104 respectively which perform a short-term Fourier analysis. The transformed signals L[j] and R[j] are thus obtained.

The block 105 performs a channel reduction matrixing, or Downmix, to obtain, from the left and right signals, a sum signal, a monophonic signal hereinafter called mono signal, in the present case, in the frequency domain.

An extraction of spatial information parameters is also performed in the block 105.

The parameters of ICLD (InterChannel Level Difference) type also called interchannel intensity differences, characterize the energy ratios for each frequency sub-band between the left and right channels.

They are defined in dB by the following formula:

$$ICLD [ k ] = 10 \cdot {log}_{10} ( \frac{{\sum }_{j = B [ k ]}^{B [ k + 1 ] - 1} L [ j ] \cdot {L}^{*} [ j ]}{{\sum }_{j = B [ k ]}^{B [ k + 1 ] - 1} R [ j ] \cdot {R}^{*} [ j ]} ) dB \qquad ( 1 )$$

in which L[j] and R[j] correspond to the (complex) spectral coefficients of the L and R channels, the values B[k] and B[k+1], for each frequency band k, define the subdivision into sub-bands of the spectrum and the symbol * indicates the complex conjugate.

A parameter of ICPD (InterChannel Phase Difference) type also called frequency sub-band phase difference, is defined according to the following relationship:

ICPD[k]=∠(Σ_{j=B[k]}^{B[k+1]-1}L[j]·R*[j]) (2)

in which ∠ indicates the argument (the phase) of the complex operand. It is also possible to define, in a manner equivalent to the ICPD, an interchannel time offset, or interchannel time difference (ICTD).

An interchannel coherence parameter ICC represents the interchannel correlation.

These ICLD, ICPD and ICC parameters are extracted from the stereo signals, by the block 105.

The mono signal is passed into the time domain (blocks 106 to 108) after short-term Fourier synthesis (inverse FFT, windowing and OverLap-Add or OLA) and a mono coding (block 109) is performed. In parallel, the stereo parameters are quantized and coded in the block 110.

In general, the spectrum of the signals (L[j],R[j]) is divided according to a non-linear frequency scale of ERB (Equivalent Rectangular Bandwidth) or Bark type, with a number of sub-bands typically ranging from 20 to 34. This scale defines the values of B(k) and B(k+1) for each sub-band k. The parameters (ICLD, ICPD, ICC) are coded by scalar quantification possibly followed by an entropic coding or a differential coding. For example, in the article mentioned previously, the ICLD is coded by a non-uniform quantizer (ranging from −50 to +50 dB) with differential coding; the non-uniform quantization step exploits the fact that the greater the ICLD value becomes, the weaker the auditory sensitivity to the variations of this parameter becomes.

In the decoder 200, the mono signal is decoded (block 201), a decorrelator is used (block 202) to produce two versions \hat{M}(n) and \hat{M}′(n) of the decoded mono signal. These two signals passed into the frequency domain (blocks 203 to 206) and the decoded stereo parameters (block 207) are used by the stereo synthesis (block 208) to reconstruct the left and right channels in the frequency domain. These channels are finally reconstructed in the time domain (blocks 209 to 214).

For the stereo synthesis performed in the block 208, there are different methods for synthesizing two stereo channels from the ICLD parameters and a decoded mono signal.

An example is described in the article by the authors Lapierre and Lefebvre, entitled “On Improving Parametric Stereo Audio Coding”, published at the 120th AES Convention, Paris, 2006.

The decoded left and right channels are synthesized—by considering only the interchannel level difference parameters—according to the following equations:

$$\begin{matrix}\{ \begin{matrix}\hat{L} [ j ] = {c}_{1} [ k ] \cdot \hat{M} [ j ] \\ \hat{R} [ j ] = {c}_{2} [ k ] \cdot \hat{M} [ j ]\end{matrix} \\ with & ( 3 ) \\ \{ \begin{matrix}{c}_{1} [ k ] = \sqrt{\frac{2 {c}^{2} [ k ]}{1 + {c}^{2} [ k ]}} \\ {c}_{2} [ k ] = \sqrt{\frac{2}{1 + {c}^{2} [ k ]}}\end{matrix} \\ where \\ c [ k ] = {10}^{ICLD [ k ] / 20} and \frac{{c}_{1} [ k ]}{{c}_{2} [ k ]} = c [ k ] . & ( 4 )\end{matrix}$$

However, to arrive at this result, a relatively strong assumption has to be made. In practice, the mono “downmix” operation is calculated as follows:

$$M [ j ] = \frac{L [ j ] + R [ j ]}{2} \qquad ( 5 )$$

the exact expression of the energy of the mono signal is as follows:

$${\vert M [ j ] \vert}^{2} = {\vert \frac{L [ j ] + R [ j ]}{2} \vert}^{2} = \frac{{\vert L [ j ] \vert}^{2} + {\vert R [ j ] \vert}^{2} + 2 L [ j ] {R [ j ]}^{*}}{4} \qquad ( 6 )$$

The formulae that give c₁[k] et c₂[k] devolve from the following energy constraint:

It is assumed that the left channel and the right channel are identical (L[j]=R[j]), and the following can be written:

|M[j]|²=L[j]R[j]* (7)

therefore,

2|\hat{M}[j]|²+|\hat{L}[j]|²+|\hat{R}[j]|² (8)

The above constraint is therefore written:

c₁[k]²|\hat{M}[j]|²+c₂[k]²|\hat{M}[j]|²=2|\hat{M}[j]|², or c₁[k]²+c₂[k]²=2 (9)

### Since

$$\frac{{c}_{1} [ k ]}{{c}_{2} [ k ]} = c [ k ] ,$$

it is found that c[k]² c₂[k]²+c₂[k]²=c₂[k]² (c[k]²+1)=2 which makes it possible to arrive at the result

$${c}_{2} [ k ] = \sqrt{\frac{2}{1 + {c}^{2} [ k ]}}$$

and, similarly

$$\frac{{{c}_{1} [ k ]}^{2}}{{c [ k ]}^{2}} + {{c}_{1} [ k ]}^{2} = \frac{{{c}_{1} [ k ]}^{2} ( {c [ k ]}^{2} + 1 )}{{c [ k ]}^{2}} = 2$$

which gives

$${c}_{1} [ k ] = \sqrt{\frac{2 {c}^{2} [ k ]}{1 + {c}^{2} [ k ]}}$$

This demonstration shows that the energy constraint |\hat{L}[j]|²+|\hat{R}[j]|²=2|\hat{M}[j]|² imposed in the techniques of the prior art of level stereo coding is valid only for the specific case of identical L and R channel sub-bands (L[j]=R[j]).

This assumption is not borne out in the case of real stereo signals, for which the left and right channels are generally different.

In the other cases, the energy of the synthesized stereo signal will not be well conserved. Also, energy compensation methods or so-called “active” downmix methods must be developed to conserve this energy.

A method based on a scale factor on the decoder is described in the document by Lapierre mentioned above.

The following example described here shows, for example, a case in which the energy constraint imposed in the techniques of the prior art is no longer applicable.

In this example, the energy of one of the two channels is dominant in a sub-band.

For the case of a sub-band reduced to a coefficient, by assuming that L[j]=1000X and R[j]=X in which X is real, the mono signal M[j]=(L[j]+R[j])/2=500.5X is deduced.

The following is therefore obtained: 2|M[j]|²=2*250500.25X²=501000.5X².

This value differs from |L[j]|²+|R[j]|²=1000001X². The consequence of this bad starting assumption is that the energy of the decoded signal is significantly less than the energy of the signal to be coded in the case where the two channels are unbalanced. In our example, the spatial information parameter is written:

$$ICLD [ k ] = 10 \cdot {log}_{10} ( \frac{{L}^{2}}{{R}^{2}} ) dB \qquad ( 10 )$$

The following is therefore obtained:

$$c [ k ] = {10}^{ICLD [ k ] / 20} = \frac{L}{R} = \frac{1000 X}{X} = 1000$$

Which gives:

$$\begin{matrix}{c}_{1} [ k ] = \sqrt{\frac{2 {c}^{2} [ k ]}{1 + {c}^{2} [ k ]}} = \sqrt{\frac{2000000}{1000001}} \approx 1.4142 & ( 11 ) \\ {c}_{2} [ k ] = \sqrt{\frac{2}{1 + {c}^{2} [ k ]}} = \sqrt{\frac{2}{1000001}} \approx 0.0014142 & ( 12 )\end{matrix}$$

The decoded values will then be:

\hat{L}[j]=c₁[k].\hat{M}[j]≈1.4142·500.5X=707.8071X instead of 1000X and

\hat{R}[j]=c₂[k].\hat{M}[j]≈0.0014142·500.5X=0.7078071X instead of X, which amounts to approximately 3 dB of loss in each channel.

For this type of case, it can be seen that it is necessary to implement an energy compensation technique which will increase the bit rate necessary to correctly synthesize the stereo signal in the decoder.

So as not to increase the bit rate necessary for the stereo coding, there is a need to perform a synthesis of a stereo signal which does not require any energy compensation.

### SUMMARY

An aspect of the present disclosure relates to a parametric decoding method for a stereo digital audio signal comprising a synthesis step for synthesizing, for each frequency sub-band, the stereo signal from a decoded mono signal obtained from a downmix of the stereo signal and from spatial information parameters of the stereo signal, such that the signals obtained are of the form:

\hat{L}[j]=c₁[j].\hat{M}₁[j]

\hat{R}[j]=c₂[j].\hat{M}₂[j]

with \hat{L}[j] and \hat{R}[j] being the channels of the synthesized signal, \hat{M}₁[j] and \hat{M}₂[j] being signals that are a function of the decoded mono signal and c₁[j], c₂[j] being gains. The gains are noteworthy in that they are calculated as follows:

$${c}_{1} [ j ] = \frac{2 \hat{I} [ j ]}{\hat{I} [ j ] + 1}$$

$${c}_{2} [ j ] = \frac{2}{\hat{I} [ j ] + 1}$$

with Î[j] being an amplitude ratio between the two channels of the stereo signal, obtained from the decoded parameters.

Thus, the application of these gains for the synthesis of the stereo signal makes it possible to do away with any compensation to be applied to conserve the energy of the signals.

In practice, through the application of these gains, the synthesis makes it possible to synthesize a stereo signal with an interchannel level difference without loss of energy.

The various particular embodiments mentioned below can be added independently or in combination with one another, to the steps of the method defined above.

In one embodiment, the signals \hat{M}₁[j] and \hat{M}₂[j] are equal to the decoded mono signal.

This applies in particular in the case where the channels of the stereo signal are not out of phase.

In another embodiment, the method also comprises a step for reception of the phases of the channels of the stereo signal and the signals \hat{M}₁[j] or \hat{M}₂[j] correspond to the decoded mono signal to which a phase-shift corresponding to the received phase is applied for each of the channels.

This applies in the case where the channels of the stereo signal are out of phase.

In yet another embodiment, one of the signals \hat{M}₁[j] and \hat{M}₂[j] corresponds to a time decorrelation of the decoded mono signal whereas the other is equal to the decoded mono signal.

This embodiment applies in the case where the synthesis takes into account not only the decoded mono signal but also the decorrelated mono signal.

An embodiment of the invention also relates to a parametric decoder for decoding a stereo digital audio signal comprising a synthesis module performing a synthesis, for each frequency sub-band, of the stereo signal from a decoded mono signal obtained from a downmix of the stereo signal and from spatial information parameters of the stereo signal, such that the signals obtained are of the form:

\hat{L}[j]=c₁[j].\hat{M}₁[j]

\hat{R}[j]=c₂[j].\hat{M}₂[j]

with \hat{L}[j] and \hat{R}[j] being the channels of the synthesized signal, \hat{M}₁[j] and \hat{M}₂[j] being signals that are a function of the decoded mono signal and c₁[j], c₂[j] being gains. The gains are calculated by the synthesis module, as follows:

$${c}_{1} [ j ] = \frac{2 \hat{I} [ j ]}{\hat{I} [ j ] + 1}$$

$${c}_{2} [ j ] = \frac{2}{\hat{I} [ j ] + 1}$$

with Î[j] being an amplitude ratio between the two channels of the stereo signal, obtained from the decoded parameters.

It also relates to a computer program comprising code instructions for implementing the steps of the decoding method as described, when they are executed by a processor.

An embodiment of the invention finally relates to a storage device that can be read by a processor storing a computer program as described.

### BRIEF DESCRIPTION OF THE DRAWINGS

Other features and advantages will become more clearly apparent on reading the following description, given only as a nonlimiting example, and with reference to the appended drawings in which:

FIG. 1 illustrates a coder implementing a parametric coding known from the prior art and described previously;

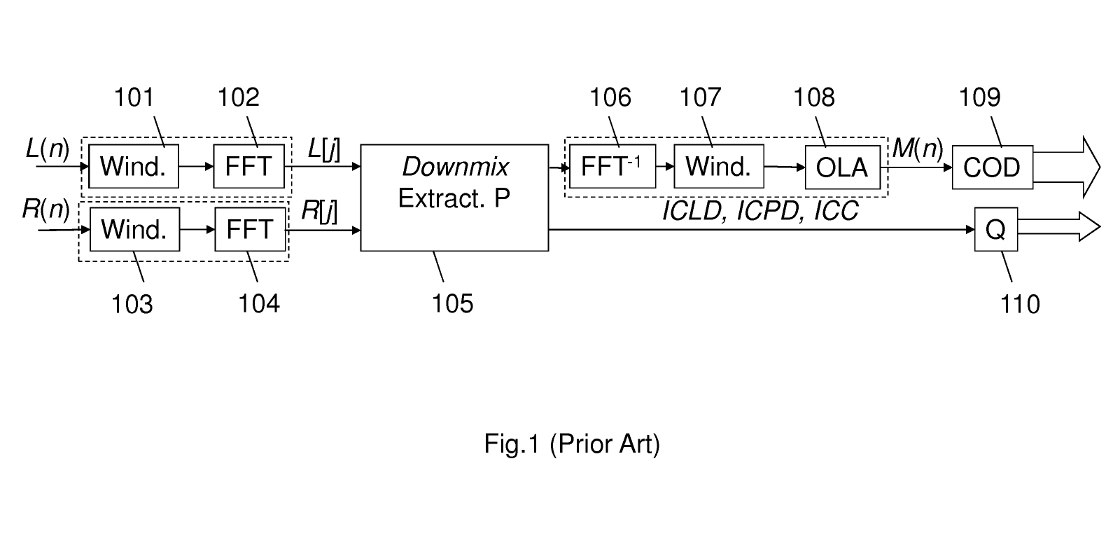

FIG. 2 illustrates a decoder implementing a parametric decoding known from the prior art and described previously;

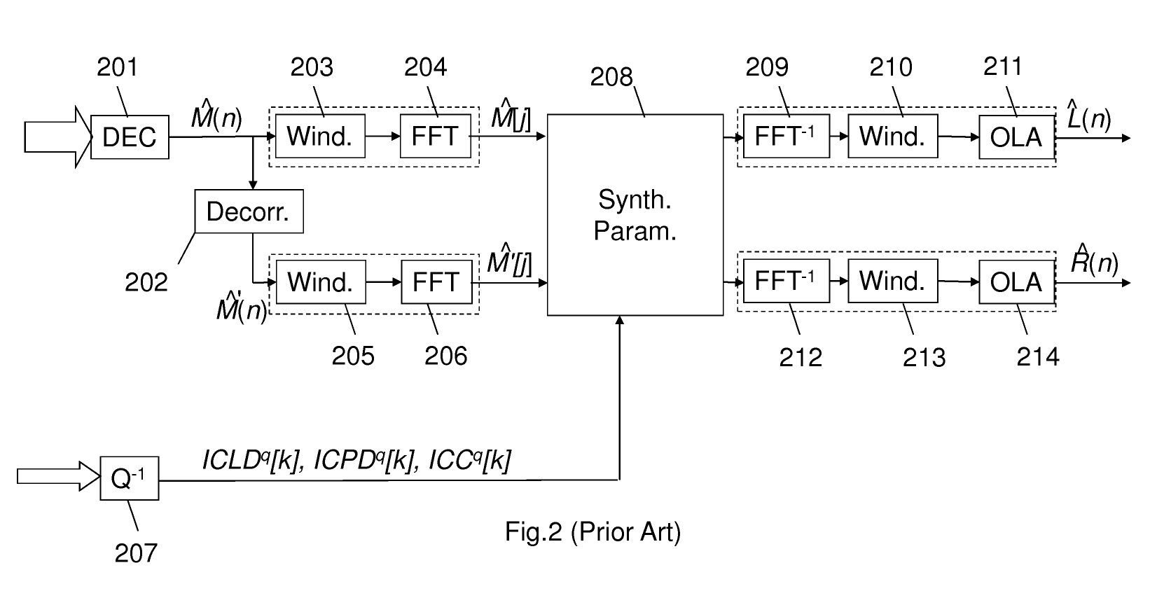

FIG. 3 illustrates a stereo parametric coder delivering a mono signal obtained from a downmix and spatial information parameters of the stereo signal;

FIG. 4 illustrates a decoder according to one embodiment of the invention, implementing a decoding method according to one embodiment of the invention;

FIG. 5 illustrates the automatic compensation effect that an embodiment of the invention makes it possible to obtain; and

FIG. 6 illustrates a device capable of implementing the decoding method according to one embodiment of the invention.

### DETAILED DESCRIPTION OF ILLUSTRATIVE EMBODIMENTS

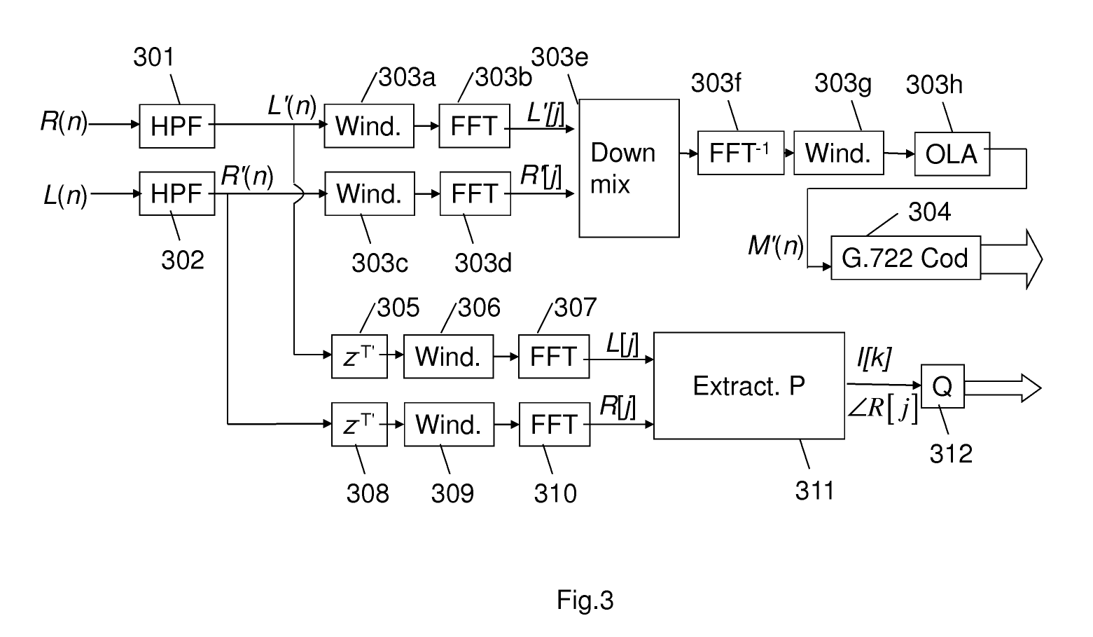

With reference to FIG. 3, a parametric stereo signal coder delivering both a mono signal and spatial information parameters of the stereo signal is now described.

It should be noted that, hereinafter in the description, the index k will be used to denote a frequency sub-band index and the index j to denote a frequency ray index.

This parametric stereo coder operates in wideband mode with stereo signals sampled at 16 kHz with 5 ms frames. Each channel (L and R) is first prefiltered by a high-pass filter (HPF) eliminating the components below 50 Hz (blocks 301 and 302).

The stereo signal is passed into the frequency domain by the blocks 303a, 303b, 303c and 303d.

The mono signal is calculated in the stereo downmix, block 303e, in which the signal is calculated in the frequency domain by the following formula:

$${M}^{′} [ j ] = \frac{\vert {L}^{′} [ j ] \vert + \vert {R}^{′} [ j ] \vert}{2} \cdot {e}^{j∠ {L}^{′} ( j )} \qquad ( 13 )$$

in which |.| represents the amplitude (complex module) and ∠(.) the phase (complex argument).

Thus, the L and R channels are set in phase in such a way that a phase ∠M(j) is chosen as reference phase for each spectral ray of the mono signal. The amplitude of the mono signal is calculated by averaging the amplitudes of the L and R channels. In the preferred embodiment, the following is set: ∠M(j)=∠R(j).

The blocks 303f, 303g and 303h are used to bring the mono signal into the time domain in order to be coded by the block 304.

The mono signal is coded by a G.722-type coder, as described, for example, in ITU-T Recommendation G.722, 7 kHz audio-coding within 64 kbit/s, November 1988.

The delay introduced in the G.722-type coding is 22 samples at 16 kHz and that of the downmix in the frequency domain is 80 samples at 16 kHz. The L and R channels are aligned in time (blocks 305 and 308) with a delay of T′=22+80=102 samples and analyzed in the frequency domain by transform, for example by discrete Fourier transform with sinusoidal windowing with overlap which, in the example here, is 50% (blocks 306, 307 and 309, 310). Each window thus covers two 5 ms or 10 ms frames (160 samples).

The block 311 is used to extract the spatial information parameters of the stereo signal.

In a particular embodiment, the calculation of the parameters is done for each frequency sub-band after a step of subdividing the spectra L[j] and R[j] into a predetermined number of frequency sub-bands, for example, here 20 sub-bands according to the scale defined below:

{B(k)}_{k=0, . . . ,20}=[0,1,2,3,4,5,6,7,9,11,13,16,19,23,27,31,37,44,52,61,80]

This scale delimits (as a number of Fourier coefficients) the frequency sub-bands of index k=0 to 19. For example, the first sub-band (k=0) goes from the coefficient B(k)=0 to B(k+1)−1=0; it is therefore reduced to a single coefficient (100 Hz).

Similarly, the last sub-band (k=19) goes from the coefficient B(k)=61 to B(k+1)−1=79, it comprises 19 coefficients (1900 Hz).

These parameters are, for example, obtained by the following calculation:

The ratio Î[k] represents the ray-by-ray amplitude ratio between the decoded left and right channels. In order to reproduce a spatial image on the decoder similar to that of the stereo signals at the input of the coder, the ratio I[k] is defined here on the coder as:

$$I [ k ] = \sqrt{\frac{{\sum }_{j = B [ k ]}^{B [ k + 1 ] - 1} L [ j ] \cdot {L}^{*} [ j ]}{{\sum }_{j = B [ k ]}^{B [ k + 1 ] - 1} R [ j ] \cdot {R}^{*} [ j ]}} \qquad ( 14 )$$

It is assumed that the ratio I[k] is coded in the logarithmic domain. It is also possible to exploit the fact that the parameter ICLD[k] for k=0 can be disregarded. Its calculation and therefore its coding can be avoided.

An example of coding of the parameters I[k] is detailed below:
for the frames of even index: coding of a block of 9 parameters {I[k]}_{k=1, . . . ,9} by non-uniform scalar quantization with:
   5 bits for the first parameter I[k] with k=1
   4 bits for the next 8 parameters I[k]
for the frames of odd index t: coding of a block of 10 parameters {I[k]}_{k=10, . . . ,19} as presented previously
   5 bits for the first parameter I[k],
   4 bits for the next 8 parameters I[k],
   3 bits for the last (tenth) parameter I[k].

Thus, in this embodiment, 37 bits are used for the frames of even index (with 3 bits of reserved usage) and 40 bits for the frames of odd index. Since the frame length is 5 ms, 40 bits are obtained per frame, or a bit rate of 8 kbit/s for the stereo extension (in addition to the G.722 coding).

A more detailed exemplary embodiment is, for example:
For the quantization table:

tab_{—}ild_{—}q5[31]={−50,−45,−40,−35,−30,−25,−22,−19,−16,−13,−10,−8,−6,−4,−2,0,2,4,6,8,10,13,16,19,22,25,30,35,40,45,50}

the 5-bit quantization of I[k]] consists in finding the quantization index i such that

i=arg min_{j=0 . . . 30}|I[k]−tab_{—}ild_{—}q5[j]|̂2

Similarly, for the quantization table:

tab_{—}ild_{—}q4[15]={−16,−13,−10,−8,−6,−4,−2,0,2,4,6,8,10,13,16}

the 4-bit quantization of I[k] consists in finding the quantization index i such that

i=arg min_{j=0 . . . 15}|I[k]−tab_{—}ild_{—}q4[j]|̂2

Finally, for the quantization table tab_ild_q3[7]={−16, −8, −4, 0, 4, 8, 16}
the 3-bit quantization of I[k] consists in finding the quantization index i such that

i=arg min_{j=0 . . . 15}|I[k]−tab_{—}ild_{—}q3[j]|̂2

In the preferred embodiment, phase ∠R[j] is also transmitted for j=2.10 with 5 bits per phase in a second 8 kbit/s extension layer. This phase is quantized with a uniform quantizer, for which the reconstruction level table is given below:

tab_phase_{—}q5[32]={0,π/16,2π/16,3π/16,4π/16,5π/16,6π/16,7π/16,8π/16,9π/16,10π/16,11π/16,12π/16,13π/16,14π/16,15π/16}

The ICLD parameter defined in the equation (1) thus corresponds to the ratio I[k], however I[k] is consistent with an amplitude ratio whereas ICLD is consistent with an energy ratio.

The embodiment described above related to the context of a wideband coder operating with a sampling frequency of 16 kHz and a particular sub-band subdivision.

In another possible embodiment, the coder can operate at other frequencies (such as 32 kHz) and with a different sub-band subdivision.

In particular, in a variant of the embodiment, the parameters are calculated ray by ray, which is equivalent to defining frequency sub-bands reduced to a Fourier coefficient; 80 sub-bands are then obtained for the example of the embodiment with 5 ms frames at a sampling frequency of 16 kHz.

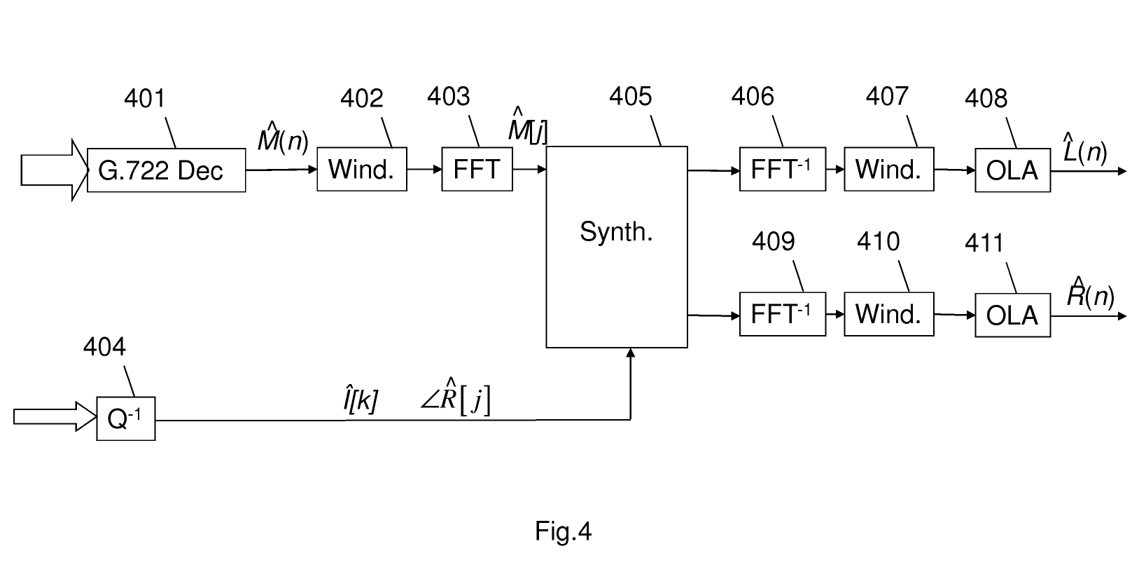

FIG. 4 illustrates a decoder in an embodiment of the invention and the decoding method that it implements.

The portion of the bit stream that is scalable in bit rate and received from the G.722 coder is demultiplexed and decoded by a G.722-type decoder (block 401) in the 56 or 64 kbit/s mode. The synthesized signal obtained corresponds to the mono signal \hat{M}(n) in the absence of transmission errors.

An analysis by short-term discrete Fourier transform with the same windowing as on the coder is performed on \hat{M}(n) (blocks 402 and 403) to obtain the spectrum \hat{M}[j].

The portion of the bit stream associated with the stereo extension is also demultiplexed in the block 404. As explained previously, it is assumed here that the coder generates two bit stream layers for the G.722 stereo extension: a first layer containing the coding indices of the parameters I[k] and a second layer containing the coding indices of the phase ∠R[j].

The operation of the synthesis block 405 is now detailed.

Initially, to simplify the description, it is assumed that the subdivision into frequency sub-bands is such that each sub-band comprises a single coefficient. Thus Î[k] becomes Î[j].

The spectra of the left and right channels are synthesized as follows:

\hat{L}[j]=c₁[j].\hat{M}₁[j]

\hat{R}[j]=c₂[j].\hat{M}₂[j] (15)

with \hat{L}[j] and \hat{R}[j] being the channels of the synthesized signal, \hat{M}₁[j] and \hat{M}₂[j] being signals that are a function of the decoded mono signal \hat{M}[j] and c₁[j], c₂[j] being gains calculated as follows:

$${c}_{1} [ j ] = \frac{2 \hat{I} [ j ]}{\hat{I} [ j ] + 1} \\ {c}_{2} [ j ] = \frac{2}{\hat{I} [ j ] + 1} \qquad ( 16 )$$

with Î[j] being an amplitude ratio between the two channels of the stereo signal, obtained from the decoded parameters.

In a preferred embodiment, \hat{M}₁[j]=\hat{M}₂[j]=\hat{M}[j] is defined when the decoder receives the first stereo extension layer at 8 kbit/s, \hat{M}₁[j]=\hat{M}[j] and \hat{M}₁[j]=\hat{M}[j].e^{j∠\hat{R}[j]}, in which ∠\hat{R}[j] is the phase decoded when the decoder also receives the second stereo extension layer at 16 kbit/s.

It should be noted that an embodiment of the invention equally applies to the more general case where \hat{M}₁[j] and \hat{M}₂[j] are derived from \hat{M}[j]. For example, in a variant, one of the signals \hat{M}₁[j] or \hat{M}₂[j] corresponds to a time decorrelation of the mono signal decoded and placed in the frequency domain whereas the other is equal to the decoded mono signal placed in the frequency domain \hat{M}[j].

According to one embodiment of the invention, the decoder does not directly receive the coded values of the two scale factors c₁[j] and c₂[j], but it decodes a parameter, here denoted Î[j], defined as the ratio between the two scale factors:

$$\hat{I} [ j ] = \frac{{c}_{1} [ j ]}{{c}_{2} [ j ]} \qquad ( 17 )$$

On the coder, as an exemplary embodiment, I[j] can be defined as the amplitude ratio of the two channels:

$$I [ j ] = \frac{\vert L [ j ] \vert}{\vert R [ j ] \vert} \qquad ( 18 )$$

and Î[j] is used to denote the reconstructed value of I[j] at the decoder.

An embodiment of the invention consists in determining the scale factors c₁[j] and c₂[j] from the ratio Î[j] by defining the following constraint on the decoded mono signal \hat{M}[j]:

$$\hat{M} ( j ) = \frac{\hat{L} ( j ) + \hat{R} ( j )}{2} \qquad ( 18 )$$

The factors c₁[j] and c₂[j] are then determined from the ratio Î[j] according to the above equation (16).

It is demonstrated below that these scale factors can be used to retrieve the stereo signal as coded.

In the particular embodiment case where \hat{M}₁=\hat{M}₂=\hat{M}[j], that is to say when the channels of the stereo signal are not out of phase, it will in fact be noted that, according to the equations (15) and (17), the decoded left and right channels are linked by the relationship:

$$\hat{L} [ j ] = \frac{{c}_{1} [ j ]}{{c}_{2} [ j ]} \hat{R} [ j ] = \hat{I} [ j ] \hat{R} [ j ] \qquad ( 19 )$$

The constraint of the equation (18) imposes:

$$\hat{M} ( j ) = \frac{\hat{I} [ t , k ] \hat{R} ( j ) + \hat{R} ( j )}{2} = \frac{( \hat{I} [ j ] + 1 ) \hat{R} ( j )}{2} \qquad ( 20 )$$

The equation (20) can be used to obtain the decoded right channel from \hat{M}[j] and from the parameter Î[j]:

$$\hat{R} ( j ) = \frac{2}{\hat{I} [ j ] + 1} \hat{M} ( j ) \qquad ( 21 )$$

Similarly, by combining the equations (16) and (21), the decoded left channel is obtained from \hat{M}[j] and from the parameter Î[j]:

$$\hat{L} ( j ) = \hat{I} [ j ] \hat{R} ( j ) = \frac{2 \hat{I} [ j ]}{\hat{I} [ j ] + 1} \hat{M} ( j ) \qquad ( 22 )$$

By comparing the equations (15), (21) and (22), the equation (16) is therefore correctly retrieved.

If it is assumed that the left and right channels (complex signals in the frequency domain) are in phase and differ only in amplitude, that is to say L[j]=I[j]R[j] in which I[j] is the amplitude ratio, it is easy to check that an embodiment of the invention makes it possible to exactly retrieve the original channels in the case of an ideal coding where Î[j]=I[j] and \hat{M}[j]=M[j]; in fact, in this case, for

$$∠ M ( j ) = ∠ R ( j ) , \\ M [ j ] = \frac{\vert L [ j ] \vert + \vert R [ j ] \vert}{2} \cdot {e}^{j∠ R ( j )} = \frac{I [ j ] + 1}{2} \vert R [ j ] \vert \cdot {e}^{j∠ R ( j )} = \frac{1 + I [ j ]}{2} R [ j ]$$

and according to the equations (21) and (22), it is found that

$$\hat{R} ( j ) = \frac{2}{\hat{I} [ j ] + 1} \hat{M} ( j ) = \frac{2}{\hat{I} [ j ] + 1} \cdot \frac{1 + I [ j ]}{2} R [ j ] = R [ j ]$$

$$and$$

$$\hat{L} ( j ) = \hat{I} [ j ] \hat{R} ( j ) = I [ j ] R [ j ] = L [ j ]$$

When the left and right channels are not in phase, that is to say when \hat{M}₁[j]≠\hat{M}₂[j], the downmix described in the equation (5) forces the alignment of the phase of these channels.

In this embodiment of the invention, the decoding method is therefore applied to exactly retrieve the amplitude ratio. However, the phases of the left and right channels have to be coded and transmitted in addition to the parameters to correctly synthesize the two channels.

If it is assumed that ∠M(j)=∠R(j), the phase of the decoded mono signal corresponds to the phase of the right channel ∠R(j) and it is sufficient to transmit the phase of the left channel ∠L(j) or vice versa if the phase of the decoded mono signal corresponds to the phase of the left channel ∠L(j).

The signals \hat{M}₁[j] and \hat{M}₂[j] then correspond to the decoded mono signal to which a phase shift corresponding to the received phase is applied for each of the channels.

In a first embodiment, the invention here assumes that the parameters I[j] are transmitted for each frequency ray. In the example described above, the spectrum comprises 80 complex rays, therefore, in principle, 80 parameters should be transmitted.

Secondly, it is assumed that the subdivision in frequency sub-bands is such that the sub-bands have a non-uniform size as in the preferred embodiment of the coder. Thus, the decoder receives as stereo parameter Î[k] which corresponds to the coded value I[k] for each sub-band for which an exemplary definition has been given previously in the equation 14.

In this more advantageous variant embodiment of the invention, the spectrum is divided into sub-bands as described with reference to FIG. 3.

On the decoder, the spectra \hat{L}[j] and \hat{R}[j] are subdivided as on the coder into 20 sub-bands according to the scale defined below:

{B(k)}_{k-0, . . . ,20}=[0,1,2,3,4,5,6,7,9,11,13,16,19,23,27,31,37,44,52,61,80]

The first sub-bands are reduced to a single (complex) coefficient which makes it possible to implement the decoding method according to an embodiment of the invention.

For the sub-bands with more than one coefficient—of index k>6—a single scale factor is used for each channel for the entire sub-band k, according to:

$$\{ \begin{matrix}\hat{L} [ j ] = {c}_{1} [ k ] \cdot \hat{M} [ j ] , \\ \hat{R} [ j ] = {c}_{2} [ k ] \cdot \hat{M} [ j ]\end{matrix} , j = B ( k ) … B ( k + 1 ) - 1 \qquad ( 23 )$$

The following is then defined

$$I [ k ] = \frac{{c}_{1} [ k ]}{{c}_{2} [ k ]} \qquad ( 24 )$$

The coder then transmits I[k].

By using the same principles as those of the embodiment described above, the following are found on the decoder:

$$\begin{matrix}\{ \begin{matrix}{c}_{1} [ j ] = \frac{2 \hat{I} [ j ]}{\hat{I} [ j ] + 1} \\ {c}_{2} [ j ] = \frac{2}{\hat{I} [ j ] + 1}\end{matrix} & ( 25 ) \\ \hat{R} ( j ) = \frac{2}{\hat{I} [ k ] + 1} \hat{M} ( j ) & ( 26 ) \\ \hat{L} ( j ) = \hat{I} [ k ] \hat{R} ( j ) = \frac{2 \hat{I} [ k ]}{\hat{I} [ k ] + 1} \hat{M} ( j ) & ( 27 )\end{matrix}$$

The advantage of this variant is that 20 parameters I[k] are transmitted instead of 80 parameters. In an optimized version, the parameter I[0], which corresponds to a 0-50 Hz band in which the interchannel level difference is not perceptually significant, is not transmitted.

The total energy—ray by ray—of the decoded stereo signal is given by:

$${\hat{L} ( j )}^{2} + {\hat{R} ( j )}^{2} = 4 \frac{{\hat{I}}^{2} [ k ] + 1}{{( \hat{I} [ k ] + 1 )}^{2}} {\hat{M} ( j )}^{2} = α ( I [ k ] ) {\hat{M} ( j )}^{2} , \\ j = B ( k ) … B ( k + 1 ) - 1$$

By noting

$$α ( I [ k ] ) = α ( \frac{1}{\hat{I} [ k ]} ) ,$$

two limit values are found:

For Î[k]=0 dB, α(I[k])=2

For Î[k]>+/−100 dB, α(I[k])=4

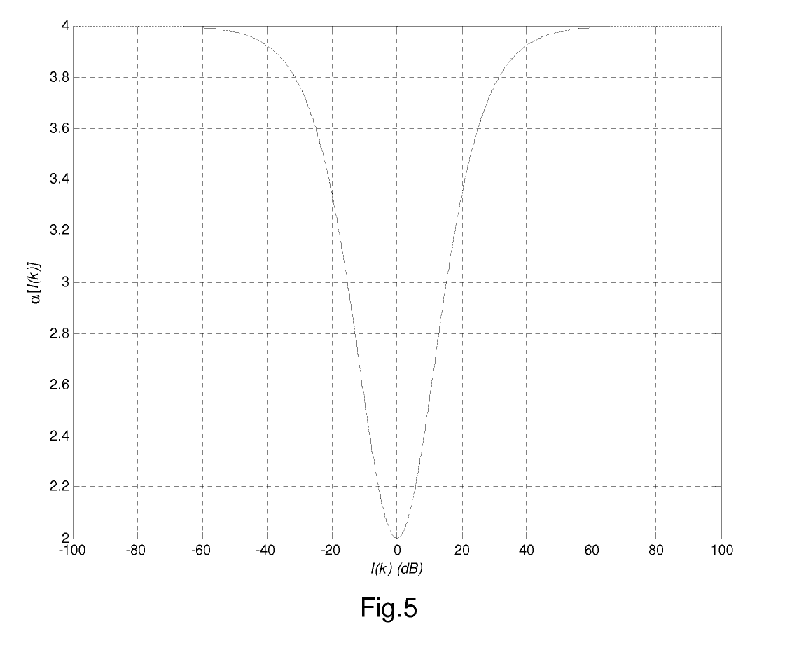

FIG. 5 illustrates the energy values as a function of the ratio I in dB. It can thus be noted that the synthesis according to an embodiment of the invention makes it possible to obtain an automatic compensation of the energy in the region where Î[k]>+/−100 dB.

This method therefore does not require any compensation technique that is costly in terms of bit rate since, by only specifically calculating the gains applied to the synthesis, this compensation can be obtained.

Referring once again to FIG. 4, the left and right channels \hat{L}(n) and \hat{R}(n) are reconstructed by inverse discrete Fourier transform (blocks 406 and 409) of the respective spectra \hat{L}[j] and \hat{R}[j] obtained from the synthesis block 405 and overlap-add (blocks 408 and 411) with sinusoidal windowing (blocks 407 and 410).

Thus, the decoder described with reference to FIG. 4, in the particular stereo signal decoding embodiment, implements a method for parametric decoding of a stereo digital audio signal comprising a synthesis step (synth.), for each frequency sub-band, for synthesizing the stereo signal from a decoded mono signal (\hat{M}[j]) obtained from a downmix of the stereo signal and from spatial information parameters of the stereo signal, such that the signals obtained are of the form:

\hat{L}[j]=c₁[j].\hat{M}₁[j]

\hat{R}[j]=c₂[j].\hat{M}₂[j]

with \hat{L}[j] and \hat{R}[j] being the channels of the synthesized signal, \hat{M}₁[j] and \hat{M}₂[j] being signals that are functions of the decoded mono signal and c₁[j], c₂[j] being gains. The gains are calculated as follows:

$${c}_{1} [ j ] = \frac{2 \hat{I} [ j ]}{\hat{I} [ j ] + 1}$$

$${c}_{2} [ j ] = \frac{2}{\hat{I} [ j ] + 1}$$

with Î[j] being an amplitude ratio between the two channels of the stereo signal, obtained from the decoded parameters.

By returning to the example mentioned at the start according to the prior art techniques with L[j]=1000X, R[j]=X, M[j]=(L[j]+R[j])/2=500.5X, and by defining I[j] as

$$I [ j ] = \frac{\vert L \vert}{\vert R \vert} = \frac{1000 X}{X} = 1000$$

disregarding the quantization error, it follows that Î[j]=I[j] and the following are obtained:

$${c}_{1} [ j ] = \frac{2 \hat{I} [ j ]}{\hat{I} [ j ] + 1} = \frac{2000}{1001}$$

$${c}_{2} [ j ] = \frac{2}{\hat{I} [ j ] + 1} = \frac{2}{1001}$$

The decoded values are then:

$$\hat{L} [ j ] = {c}_{1} [ k ] \cdot \hat{M} [ j ] = \frac{2000}{1001} \cdot 500.5 X = 1000 X$$

$$\hat{R} [ j ] = {c}_{2} [ k ] \cdot \hat{M} [ j ] = \frac{2}{1001} \cdot 500.5 X = X$$

Exactly the values to be coded are thus retrieved on the decoder, without the need for a correction factor. This technique is therefore more effective than that used in the prior art.

An embodiment of the invention has been described here in the case of a G.722 coder/decoder. It can obviously be applied in the case of a modified G.722 coder, for example including noise reduction (or “noise feedback”) mechanisms or including a scaleable extension of G.722 with additional information. An embodiment of the invention can also be applied in the case of a mono coder other than that of G.722 type such as, for example, a G.711.1-type coder. In the latter case, the delay T can be adjusted to take account of the delay of the G.711.1 coder.

Similarly, the time-frequency analysis of the embodiment described with reference to FIG. 3 could be replaced according to different variants:
a windowing other than the sinusoidal windowing could be used,
an overlap other than the 50% overlap between successive windows could be used,
a frequency transform other than Fourier transform, for example a modified discrete cosign transform (MDCT), could be used.

The embodiments described previously dealt with the case of a multichannel signal of stereo signal type, but the implementation of the invention extends also to the more general case of the coding of multichannel signals (with more than two audio channels) from a mono or even stereo downmix.

In this case, the coding of the spatial information involves the coding and transmission of spatial information parameters. Such is, for example, the case with signals with 5.1 channels comprising a left channel (L), right channel (R), center channel (C), left rear (or Left surround, Ls) channel, right rear (or Right surround, Rs) channel and subwoofer (Low Frequency Effects, LFE). The spatial information parameters of the multichannel signal then take into account the differences or the consistencies between the different channels.

The coders and decoders as described with reference to FIGS. 3 and 4 can be incorporated in a multimedia equipment item of room decoder, computer type or even a communication equipment item such as a cellphone or personal digital assistant.

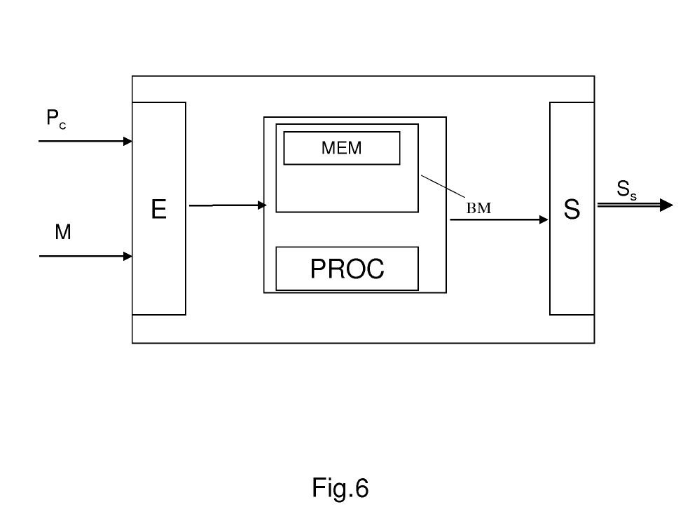

FIG. 6 represents an example of such a multimedia equipment item or decoding device comprising a decoder according to an embodiment of the invention.

This device comprises a processor PROC cooperating with a memory block BM comprising a storage and/or working memory MEM.

The memory block may advantageously contain a computer program comprising code instructions for implementing the steps of the decoding method in the sense of an embodiment of the invention, when these instructions are executed by the processor PROC, and in particular the step of synthesis (synth.), for each frequency sub-band, of the stereo signal from a decoded mono signal (\hat{M}[j]) obtained from a downmix of the stereo signal and from spatial information parameters of the stereo signal, such that the signals obtained are of the form:

\hat{L}[j]=c₁[j].\hat{M}₁[j]

\hat{R}[j]=c₂[j].\hat{M}₂[j]

with \hat{L}[j] and \hat{R}[j] being the channels of the synthesized signal, \hat{M}₁[j] and \hat{M}₂[j] being signals that are functions of the decoded mono signal and c₁[j], c₂[j] being gains. The gains are calculated as follows:

$${c}_{1} [ j ] = \frac{2 \hat{I} [ j ]}{\hat{I} [ j ] + 1}$$

$${c}_{2} [ j ] = \frac{2}{\hat{I} [ j ] + 1}$$

with Î[j] being an amplitude ratio between the two channels of the stereo signal, obtained from the decoded parameters.

Typically, the description of FIG. 4 reprises the steps of an algorithm of such a computer program. The computer program can also be stored on a memory medium that can be read by a reader of the device or that can be downloaded into the memory space of the equipment.

The device comprises an input module suitable for receiving the coded spatial information parameters P_{c} and a mono signal M originating for example from a communication network. These input signals may originate from a read on a storage medium.

The device comprises an output module suitable for transmitting a stereo signal Sₛ decoded by the decoding method implemented by the equipment.

This multimedia equipment item may also comprise a playback device of a loudspeaker type or s communication device suitable for transmitting this stereo signal.

1. A parametric decoding method for a stereo digital audio signal having at least two channels, the method comprising:
synthesizing, for each frequency sub-band, the stereo signal from a decoded mono signal (\hat{M}[j]) obtained from a downmix of the stereo signal and from spatial information parameters of the stereo signal, such that the signals obtained are of the form:
\hat{L}[j]=c₁[j].\hat{M}₁[j]
\hat{R}[j]=c₂[j].\hat{M}₂[j]
with it \hat{L}[j] and \hat{R}[j] being channels of the synthesized signal, \hat{M}₁[j] and \hat{M}₂[j] being signals that are a function of the decoded mono signal and c₁[j], c₂[j] being gains, wherein the gains are calculated as follows:
$${c}_{1} [ j ] = \frac{2 \hat{I} [ j ]}{\hat{I} [ j ] + 1}$$
$${c}_{2} [ j ] = \frac{2}{\hat{I} [ j ] + 1}$$
with Î[j] being an amplitude ratio between the two channels of the stereo signal, obtained from the decoded parameters.

2. The method as claimed in claim 1, wherein the signals \hat{M}₁[j] and \hat{M}₂[j] are equal to the decoded mono signal.

3. The method as claimed in claim 1, wherein the method also comprises receiving phases of the channels of the stereo signal and wherein the signals \hat{M}₁[j] or \hat{M}₂[j] correspond to the decoded mono signal to which a phase-shift corresponding to the received phase is applied for each of the channels.

4. The method as claimed in claim 1, wherein one of the signals \hat{M}₁[j] and \hat{M}₂[j] corresponds to a time decorrelation of the decoded mono signal whereas the other is equal to the decoded mono signal.

5. A non-transitory computer-readable memory comprising a computer program stored thereon and comprising code instructions for implementing a parametric decoding method for a stereo digital audio signal having at least two channels, when the instructions are executed by a processor, wherein the instructions comprise:
instructions configured to synthesize, for each frequency sub-band, the stereo signal from a decoded mono signal (\hat{M}[j]) obtained from a downmix of the stereo signal and from spatial information parameters of the stereo signal, such that the signals obtained are of the form:
\hat{L}[j]=c₁[j].\hat{M}₁[j]
\hat{R}[j]=c₂[j].\hat{M}₂[j]
with it \hat{L}[j] and \hat{R}[j] being channels of the synthesized signal, \hat{M}₁[j] and \hat{M}₂[j] being signals that are a function of the decoded mono signal and c₁[j], c₂[j] being gains, wherein the gains are calculated as follows:
$${c}_{1} [ j ] = \frac{2 \hat{I} [ j ]}{\hat{I} [ j ] + 1}$$
$${c}_{2} [ j ] = \frac{2}{\hat{I} [ j ] + 1}$$
with Î[j] being an amplitude ratio between the two channels of the stereo signal, obtained from the decoded parameters.

6. A parametric decoder for decoding a stereo digital audio signal having at least two channels, the decoder comprising:
a synthesis module device configured to perform a synthesis, for each frequency sub-band, of the stereo signal from a decoded mono signal obtained from a downmix of the stereo signal and from spatial information parameters of the stereo signal, such that the signals obtained are of the form:
\hat{L}[j]=c₁[j].\hat{M}₁[j]
\hat{R}[j]=c₂[j].\hat{M}₂[j]
with \hat{L}[j] and \hat{R}[j] being the channels of the synthesized signal, \hat{M}₁[j] and \hat{M}₂[j] being signals that are a function of the decoded mono signal and c₁[j], c₂[j] being gains, wherein the gains are calculated by the synthesis module, as follows:
$${c}_{1} [ j ] = \frac{2 \hat{I} [ j ]}{\hat{I} [ j ] + 1}$$
$${c}_{2} [ j ] = \frac{2}{\hat{I} [ j ] + 1}$$
with Î[j] being an amplitude ratio between the two channels of the stereo signal, obtained from the decoded parameters.
